(19) United States
(12) Patent Application Publication
(10) Pub. No.: US 2011/0073094 A1
(43) Pub. Date: Mar. 31, 2011

(54) ABRASIVE ARTICLE WITH SOLID CORE AND METHODS OF MAKING THE SAME

(75) Inventors: Naum N. Tselesin, Atlanta, GA (US); Brian D. Goers, Minneapolis, MN (US)

(73) Assignee: 3M Innovative Properties Company

(21) Appl. No.: 12/567,937

(22) Filed: Sep. 28, 2009

(51) Int. Cl. B28D 1/04; B24D 11/00; B24D 9/00; B24D 5/00

(52) U.S. Cl. 125/15; 51/307; 451/548

(57) ABSTRACT

Abrasive articles and method of making said articles are provided. The articles include an integral resilient member having a first and a second opposed major surface where the member includes a centrally disposed core that is substantially free of abrasive particles and a peripheral annulus that includes a plurality of abrasive zones that comprise abrasive particles. The particles protrude through at least one major surface of the integral member.

### FIELD

Abrasive articles and methods of making the abrasive articles are provided.

### BACKGROUND

Abrasive articles can be used to grind and polish surfaces, to apportion materials into different pieces, or to cut unwanted material away during processing of forming a useful part from stock material. Abrasive saws or circular blades are well known and can be used throughout a number of industries, including the electronics industry, to form useful parts. A recent trend has been to make abrasive saws or blades that are flexible and/or thin and that have abrasive particles fixed in a matrix and/or onto blade carrier in a predetermined pattern. But the thin carrier and/or matrix material can make the blade not have mechanical integrity for cutting, especially precision cutting or making thin slots (gaps, kerfs) in the work piece (dicing). Additionally, blades that have screened or mesh wheels as cores and incorporate abrasive particles are prone to cracking. Coating (for example, electrodepositing or electroforming) the edges of blades with abrasive particles does not provide blades with sufficient retention of abrasive particles for good integrity and with desired longevity when making precision cuts. Current blades can make cuts (for example, precision cuts) that have a width of around 1 mm or less.

Abrasive articles include sintered abrasive materials having a first portion containing a plurality of abrasive particles and a second portion, called a “foot”, along one side of that first portion. The foot has no abrasive particles and enables the articles to be readily attached to a cutting tool.

### SUMMARY

As the electronics and other industries require parts that are increasingly smaller, abrasive articles are needed that can cut very thin kerfs in hard materials. There is also a need in these industries for abrasive articles that can make precise cuts with a minimum number and size of defects left on the machined surface, and can resist wear or erosion of the cutting surface during use. There is also a need for abrasive articles that are very thin, but are reinforced and also may have patterned hard abrasive articles embedded in therein.

In one aspect an abrasive article is provided that includes an integral resilient member, having first and second opposed major surfaces, the member comprising a centrally disposed core and a peripheral annulus comprising a plurality of openings or cells, wherein the peripheral annulus comprises a plurality of abrasive zones that comprise abrasive particles that protrude through at least one of the major surfaces of the integral resilient member, wherein the abrasive zones extend outwardly from the at least one major surface, and wherein the core is substantially free of abrasive zones.

In another aspect, an abrasive article is provided that includes two or more integral resilient members, each member having a first and second opposed major surface, at least one of the members comprising a centrally disposed core and a peripheral annulus comprising a plurality of openings or cells, and an interlayer disposed between and in contact with at least one major surface of each member, wherein the peripheral annulus comprises a plurality of abrasive zones that comprise abrasive particles that protrude through the at least one major surface of the integral resilient member, wherein the abrasive zones extend outwardly from the at least one major surface, wherein the core is substantially free of abrasive zones, and wherein the interlayer comprises an abradable material.

In another embodiment, an abrasive disc is provided that includes an abrasive layer having first and second opposed major surfaces comprising a plurality of openings or cells; and at least one layer of support material disposed upon at least one side of the abrasive layer,

wherein the abrasive layer comprises a plurality of abrasive zones that comprise abrasive particles that protrude through at least one of the major surfaces of the abrasive layer, wherein the abrasive layer extends beyond the at least one layer of support material and forms a peripheral annulus, and wherein the at least one layer of support material forms a supporting flange for the abrasive disc. In some embodiments, the abrasive disc can include two layers of support material, one layer disposed upon the first major surface of the abrasive layer and one layer disposed upon the second major surface of the abrasive layer.

In yet another aspect, a method of making an abrasive article is provided that includes providing an integral resilient member having a first and second opposed major surface, the member comprising a centrally disposed core and a peripheral annulus comprising a plurality of openings or cells, wherein the cells can penetrate through at least one major surface of the integral resilient member, and wherein the core is substantially free of cells, disposing abrasive particles into the cells, and processing the integral resilient member so that the abrasive particles are fixed in the cells.

In another aspect, a method of making an abrasive article is provided that includes the steps of providing an integral resilient member having first and second opposed major surfaces, the member comprising a centrally disposed core bonding a peripheral annulus having openings or cells onto the centrally disposed core using laser or electron beam welding, brazing, soldering, heating, sintering, fusing, infiltrating, pressurizing, stamping, forging, or a combination thereof, wherein the peripheral annulus comprises at least one abrasive zone that comprises abrasive particles that protrude from at least one major surface of the integral resilient member, wherein the abrasive zones extend outwardly from at least one major surface, and wherein the core is substantially free of abrasive zones.

In yet another aspect a method of making an abrasive disc is provided that includes providing a sheet that includes an abrasive layer having first and second opposed major surfaces comprising a plurality of openings or cells and at least one layer of support material disposed upon at least one side of the abrasive layer, etching through the at least one layer of support material to expose the abrasive layer; and extracting the abrasive disc from the sheet,

wherein the abrasive layer comprises a plurality of abrasive zones that comprise abrasive particles that protrude through at least one of the major surfaces of the abrasive layer, and wherein the abrasive layer extends beyond the at least one layer of support material and forms a peripheral annulus, and wherein the at least one layer of support material forms a supporting flange for the abrasive disc.

As used herein:

the term “abrasive zone” refers to an area of a peripheral annulus of the provided resilient member that has abrasive particles and can refer to a cell or at least one plurality of cells containing at least one diamond;

the term “arbor” refers to an axis or shaft that supports a rotating part;

the terms “cell” and “opening” refer to a through or blind hole, channel, or cavity in a material that can have any shape—round, rectangular, square, octagonal, or irregular;

the terms “cellular material”, “cell material”, and “mesh material” refer to materials comprising at least one plurality of openings and includes meshes, cut or expanded materials, for example, metals, eroded, etched, bombarded, drilled and pierced materials, porous materials, and screens;

the term “the core is substantially free of abrasive zones” refers to less than 5% of the area of the core having abrasive zones;

the term “the core is substantially free of openings or cells” refers to less than 5% of the area of the core having openings or cells;

the term “diamond” refers to any type of hard abrasive particle that can have any shape and form and includes single particles (stone), agglomerates, granules, clusters, and their pluralities;

the term “disc” refers to a thin, flat, circular object or a shape resembling such an object;

the term “extracted” refers to at least one article that has been removed from a piece that is larger than the article, for example, a web or plate of multiple articles by any one of a number of separating processes defined herein;

the term “fin” refers to an outer peripheral annulus of a resilient member that has a thickness that is smaller than at least one part of the disc to which it is attached;

the term “integral member” and “integral resilient member” and “resilient member” refers to a disc, plate, or foil that is a complete unit wherein the centrally disposed core section, peripheral annuluses, if more than one, and, optionally fins are all part of the same structure;

the term “preform” refers to sinterable materials before they are processed (sintered);

the term “resilient” refers to the property of a material that allows it to be flexible and to resume its original shape quickly after being bent, twisted, stretched, or compressed;

the term “substantially solid” refers to a material that does not flow or change shape at least over a useful life of the abrasive tool, for example, blade, except of being abraded away during a process of utilization of the abrasive tool; and

the term “support flange” refers to a circular collar that is coaxial with an arbor and supports an integral resilient member.

The provided articles and methods can satisfy a market need for very thin abrasive blades, typically on the order of 250 micrometers or less, 100 micrometers or less, or even 50 micrometers or less in thickness that are resilient, can be reinforced, and can be used for making very precise, thin cuts, in a variety of materials, including silicon and silicon dioxide, titanium aluminates, glasses, ceramics and may be used in semiconductor wafer dicing applications. The articles may also be useful for polishing areas on electronic components such as silicon wafers, titanium aluminates, composites, glasses, ceramics, silicon, chips, circuit boards, integrated circuits, or can be used for cutting and polishing operations in the nanofabrication industry or precision stone industry (for example, machining rubies).

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a top-down view of a plate from which a provided integral resilient member can be extracted.

FIGS. 1A-1C are edge-on views of various embodiments of plates of FIG. 1.

FIG. 2 is a top-down view of a provided integral resilient disc.

FIGS. 2A and 2B are edge-on views of embodiments of the member of FIG. 2.

FIG. 2C is an exploded view of a portion of FIG. 2A.

FIG. 3 is a top-down view and FIG. 3A is an edge-on view of a provided integral resilient disc.

FIGS. 3B and 3C are edge-on views of embodiments of provided integral resilient members.

FIGS. 4A and 4B are edge-on views of embodiments of provided integral resilient discs that include a retention material that includes abrasive particles.

FIGS. 5A and 5B are edge-on views of embodiments of provided integral resilient members that include fins.

FIG. 6A is an edge-on view of an embodiment of a provided integral resilient member.

FIGS. 6B and 6C are edge-on views of embodiments of provided integral resilient members that include a shaft opening and a support flange.

FIG. 7 is a top-down view of a mask that can be used to make an embodiment of the provided integral resilient member.

FIG. 7A is an edge-on view of the mask in FIG. 7 that includes an adhesive sheet.

FIG. 7B is an exploded view of the indicated portion of FIG. 7A.

FIGS. 8A and 8B illustrate two steps in a process for making provided integral resilient members.

FIGS. 9A-9C illustrate an embodiment of the provided article that includes a support flange.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Abrasive articles are provided that are useful for making very thin or narrow kerfs, cuts, or grooves in very hard materials such as those useful, for example, in the electronics industry. The provided articles include integral resilient members that have first and second opposed major surfaces. Typically the integral resilient members can be in the shape of discs. The contemplated discs are generally circular and similar to saw blades. However, they may have other shapes depending upon their use. When used to cut a groove or kerf, they are typically circular. But they can also be of other shapes, for example, elongated reciprocating blades, which can be useful both for cutting and polishing.

Typically, the provided articles are somewhat axially or radially symmetric allowing them to be used by mounting them on a spindle (one or multiple blades on the spindle, a gang saw) and rotating the spindle. It is also contemplated that the discs can be corrugated or-folded with corrugations, for example, pleated with the fold of the pleats in a radial direction. The abrasive articles are resilient in that they can be—to some extent—flexed, bent, twisted, expanded, stretched, or compressed, but then can quickly regain their previous shape. In this manner they can resist losing pieces, chipping, breaking, or cracking when utilized. The resilient property also allows the blades to take full advantage of the properties of the hard abrasive materials included therein.

The provided integral resilient members, for example, discs, can be substantially solid and include a centrally disposed core that is substantially free of abrasive zones. The members have a first and a second opposed major surface. Typically, there are no abrasive zones in the centrally disposed core but this centrally disposed core can comprise an opening for a shaft of a rotating tool. Extending radially outward from and in contact with the centrally disposed core can be one or more abrasive zones and/or pluralities of cells that form at least one peripheral annulus. Each peripheral annulus can have at least one plurality of abrasive zones or cells arranged randomly or in one or more patterns or arrays. The abrasive zones or cells can receive or include diamonds that can extend or protrude from at least one of the major surfaces of the integral resilient member. The size (largest diameter) of individual diamonds can be equal to, smaller than, or larger than the distance between the two major surfaces of the integral resilient member. Some diamonds can protrude through at least one of the major surfaces of the resilient member or can protrude through both major surfaces of the integral resilient member. In some embodiments, at least some, typically the majority of the openings or cells of the integral resilient member are filled with diamonds and diamond retention material. The retention material provides integrity not only by holding the diamonds in place, but also to the integral resilient member, for example, by a way of at least partially fusing and/or diffusing with at least some elements of the material of the integral resilient member, and/or filling the openings or cells.

In some embodiments, an adhesive or tacky material, for example, a pressure sensitive adhesive, can block at least some openings or cells from one of the major surfaces of the integral resilient disc. This adhesive or tacky material can temporarily retain diamonds in the openings or cells of the integral resilient member, typically in the annulus, before such temporarily retention of the diamonds is replaced by another type of retention, for example, with a permanent retention of the diamonds by the sintered or deposited material. In some embodiments, the integral resilient member can be utilized as a mask for orderly distributing or patterning of the diamonds. Exemplary masks for distributing abrasive particles/diamonds and their utilization in the provided abrasive articles are disclosed, for example, in U.S. Pat. Nos. 4,925,457; 5,092,910; 5,049,165; and 5,620,498 (all Tselesin). There can be one or more than one diamond in an opening or cell. The outermost peripheral annulus can be a fin if it has a smaller thickness than the core or the part of the member with which the annulus is in contact or to which the annulus is attached. The diameter of the outermost point of the centrally disposed core can be from about 50.0% to about 99.5% of the diameter of the outermost point of the most distal peripheral annulus.

The provided resilient member can be very thin and can have a thickness of about 250 micrometers or less, about 100 micrometers or less, or even about 50 micrometers or less at its thickest point. The resilient member can have the same thickness over its entirety or it can have different zones that have varying thicknesses. The different zones can extend radially from the center of the resilient member, for example, disk, and can include the centrally disposed core and any peripheral annuluses that includes an outermost annulus which can be known as a fin if it has a thickness less than that of the core of the resilient member or the peripheral annulus to which it is affiliated, connected, integrated, or attached. Fins can have a thickness of less than about 100 micrometers, less than about 60 micrometers, or even less than about 30 micrometers; or a thickness that is about the same or less than the average diameter of the diamonds.

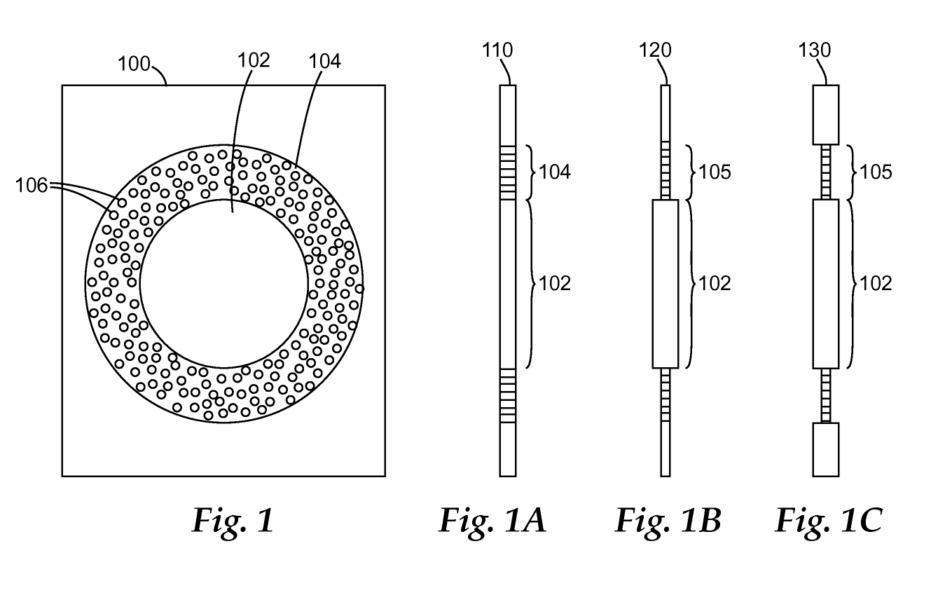

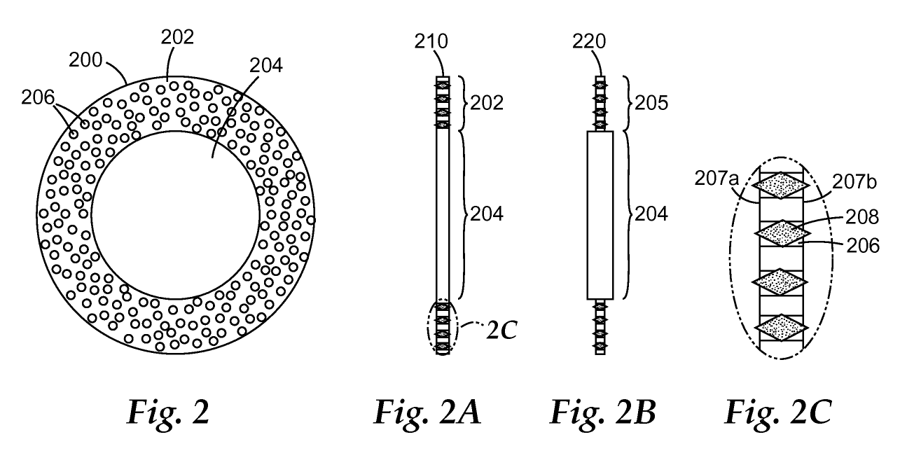

The provided articles can be further understood by examining the drawings. FIG. 1 is a top-down view of plate or sheet or foil or mask 100 from which provided articles can be extracted by suitable extracting means such as laser cutting, abrasive cutting, edge tool cutting, water jet cutting, electroerosion cutting, and mechanical distraction (breakage, stamping), or any combination of these methods. Plate 100 has a centrally disposed core 102 and peripheral annulus 104. Both centrally disposed core 102 and peripheral annulus 104 have a first major surface (shown in drawing) and a second opposed major surface (below the plane of the paper). Core 102 and annulus 104 are in contact with each other. Peripheral annulus 104 includes a plurality of abrasive zones that include cells 106 where abrasive particles can be placed. Peripheral annulus 104 includes cells, holes, perforations, grooves, or other voids, for example, cellular or porous regions, also known as abrasive zones, that can extend from one side of the article through the article to the other side of the article. As can be seen in FIGS. 2A-2C, cells of the annulus and the corresponding abrasive zones can contain one or more abrasive particles.

FIGS. 1A-1C are edge-on views of various embodiments of plate or foil 100. Each embodiment has a centrally disposed core 102 and a peripheral annulus 104 or a fin portion 105. In the embodiment illustrated in FIG. 1A, the thickness of the core 102 and the annulus 104 are the same and are the same thickness as the plate 110. In the embodiment illustrated in FIG. 1B, the core 102 is thicker than the annulus 105, the core having the same thickness as the plate 120. When the annulus 105 is thinner than the core, it is referred to as a fin. FIG. 1C shows an embodiment wherein the core 102 is thicker than the fin 105 but where the core and the plate periphery 130 are of the same thickness. Other embodiments such as those that include a centrally disposed core and more than one portion that include a plurality of abrasive zones are also contemplated. Provided abrasive articles (integral resilient discs) can be extracted from a plate using techniques described herein. In some embodiments, plates can contain multiple preforms or zones, areas of provided discs. These multiple preforms may be different in size, shape, or arrangement on the plates. In some embodiments, plates can be webs, for example, with very long lengths from which provided abrasive articles can be extracted.

The plate and the centrally disposed core of the abrasive article and the peripheral annulus or portions if there are multiple regions of abrasive zones can be made of the same materials or different materials. They are generally made of a material that can include a metal, steel, alloy, deposited substance, or sintered or sinterable materials in the form of powders or preforms. These materials can comprise at least one element from Groups 3-15 of the Periodic Table. Typically, for different applications of the abrasive tool, for example, of the blades, the elements, or complete (entire) materials of the plate 100, are selected from copper, nickel, iron, molybdenum, cobalt, aluminum, and zirconium, steel, stainless steel, bronze, and combinations thereof.

FIG. 2 is a top-down view of an exemplary provided integral resilient disc or mask 200 that has been extracted or cut from a plate such as that illustrated in FIG. 1. Disc 200 has centrally disposed core 204, peripheral annulus 202 with one region that includes a plurality of cells 206 that contain abrasive particles 208. FIGS. 2A and 2B are edge-on views of two embodiments 210 and 220. Embodiment 210 has centrally disposed core 204 and peripheral annulus 202. FIG. 2C is an exploded view of peripheral annulus 202 of embodiment 210 and includes hard abrasive particles 208 located within cells 206. The hard abrasive particles can extend from the first major surface 207a to the second major surface 207b through the integral resilient disc. Embodiment 220 has fin 205 (outermost peripheral annulus) that includes abrasive particles in a manner analogous to embodiment 210. Temporary or permanent retention material of diamonds is not shown within cells 208 for clarity of illustration. Optional presence of retention material onto major surfaces 207a and 207b is also not shown.

At least part of the sinterable material used to form the peripheral abrasive annulus of the integral resilient disc can substantially fill the cells sufficiently to encapsulate the hard abrasive particles and act as retention material. The entire plate or disc can be heated, for example, sintered, with or without compression, or brazed or plasma sprayed, to bind the abrasive particles or fibers with retention material derived from powder particles, if present, of the retention material together and hold the abrasive particles in place. Alternatively, depending upon the final characteristics of the abrasive article desired, the retention material can include a resin, rubbers, or a similar polymeric material. A thermoplastic can be used, the thermoplastic being heated to encapsulate the particles, and subsequently cooled to hold the particles in place. A thermosetting resin can be used, the cells being filled with the resin, and then the resin cured by heat, moisture, or electromagnetic energy to hold the abrasive particles in place.

Retention material for holding the abrasive particles can comprise at least one element selected from Groups 3-15 of the Periodic Table. Typically, for different applications, the abrasive articles (blades) and different abrasive particles, can include at least one element selected from copper, nickel, cobalt, iron, molybdenum, aluminum, zirconium, chromium, tungsten, titanium, phosphorous, silicon, tin, bismuth, zinc, and combinations thereof. Some of these materials, for example, tungsten, chromium, titanium, can form carbides with the carbon of diamonds that results in enhancing retention of diamond in the sintered retention material. Sinterable retention materials (so called “matrix materials”) are well known to those having ordinary skill in the art of abrasive articles and include metal powders, metal fiber compositions, powder, or fiber mixtures, all either free or preformed. Exemplary sinterable sintered materials and their utilization in the provided abrasive articles are disclosed, for example, in U.S. Pat. Nos. 4,925,457; 5,092,910, 5,049,165; and 5,620,498 (all Tselesin).

Alternatively, depending upon the final characteristics of the abrasive article desired, the matrix material can include a resin, rubbers, ceramic composites, or other polymeric materials. A thermoplastic can be used, the thermoplastic being heated to encapsulate the particles, and subsequently cooled to hold the particles in place. A thermosetting resin can be used, the cells being filled with the resin, and then the resin cured, for example, by heat, moisture, or electromagnetic energy, to hold the particles in place. Alternatively, retention of abrasive particles can be provided by electrodeposition methods (for example, electro-coating or electro-forming methods) or chemical or physical vapor deposition methods and can comprise carbide forming elements, (for example, boron, silicon, chromium, titanium or tungsten) and/or an(other) element listed in Groups 3-15 of the Periodic Table (for example, nickel, molybdenum, copper, or aluminum).

As mentioned above, the abrasive particles can include a great variety of materials. Diamonds, synthetic or natural, are well known and frequently used as cutting, grinding, or polishing abrasive materials, but numerous other hard substances are also useful. For example, cubic boron nitride, boron carbide, tungsten carbide, silicon carbide or other carbides, or crushed cemented carbides as well as aluminum oxide or other ceramics can be used. Typical are abrasive particles have a Mohs hardness of 8 or greater. Also mixtures of these materials can be used as abrasive materials. Other exemplary abrasive particles are disclosed, for example, in U.S. Pat. No. 5,791,330 (Tselesin).

In some applications, it may be desired to have abrasive particles of similar size, for example, the abrasive particles may have a narrow particle size distribution. This can allow the abrasive particles to protrude from the peripheral annulus at a more uniform level creating a more uniform abrading and abraded surface of the machined work-piece. Size uniformity of abrasive particles can result in a smaller and fewer chips left by the abrasive tool on the abraded (for example, cut or ground) surface. In other instances, it may be desired to have a broader particle size distribution, creating a more uneven distribution of particle heights protruding from the peripheral annulus. This can allow the larger particles that are protruding further from the peripheral annulus to exhibit higher local pressure during a cutting application resulting in a more aggressive (for example, faster) machining but a rougher (morphology of) the abraded surface. Mixtures of abrasive particle sizes and/or abrasive particle size distributions may be used either with the same type of abrasive particles or with mixtures of two or more different types of abrasive particles.

The abrasive particles in two different cell and/or abrasive regions can be different in composition, size, shape, and physical/mechanical properties. Typically, the centrally disposed core is substantially free of abrasive particles. If a plate comprising at least one abrasive zone is used to extract the provided abrasive articles, at least some areas of the plate beyond the outmost peripheral annulus can also be substantially free of abrasive particles. This can aid in the extraction of the products from the plate or structure used to form them—especially when the abrasive particles are diamonds, for example, in U.S. Pat. No. 6,482,244 (Tselesin). The abrasive particles can be randomly or non-randomly distributed in one or more regions or in selected areas of the disc. Typically the abrasive particles are distributed non-randomly in at least one of the peripheral annuluses of the disc. The hard abrasive particles can be single particles or can be in the form of agglomerates or granules that include individual hard particles.

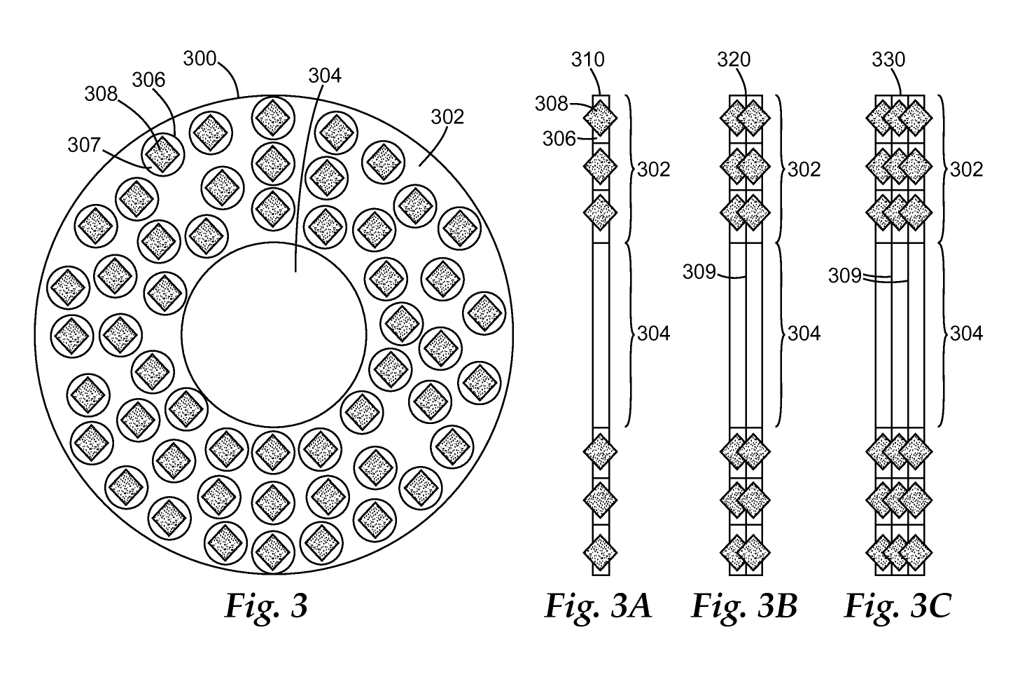

FIG. 3 is a top-down illustration of embodiment 300 of a circular resilient abrasive disc that includes centrally disposed core 304 and peripheral annulus 302. Within peripheral annulus 302 are a plurality of cells defining a plurality of abrasive zones. Within cells 306 are disposed at least one hard abrasive particle 308 that is held in place by retention material 307 within the cells. An external layer (not shown for a purpose of clarity in FIGS. 3, 3A and 3B) for example, retention material 307, can cover at least a portion of the surface of at least one facet (side) of the disc, such surface may include a surface between the cells 306, and such an external layer may or may not include hard abrasive particles in a random or patterned array (arrangement). FIG. 3A is an edge-on view of one embodiment 310 that has centrally disposed core 304, peripheral annulus 302 where peripheral annulus 302 includes cells 306 each containing a hard abrasive particle 308. The cells can also contain retention material 307.

In another embodiment, 320, shown in FIG. 3B, the abrasive disc comprises two resilient discs bonded using interlayer 309. This embodiment includes centrally disposed core 304 and peripheral annulus 302. Interlayer 309 can be an adhesive or diamond retention material or any other material that securely bonds the two discs together. In some embodiments the discs can be welded, brazed, soldered, glued, or bonded together by any other method known to those having ordinary skill in the art, for example, by sintering, thus providing interlayer 309 having retention material 307. FIG. 3C is another embodiment 330 of a provided abrasive article that includes three resilient abrasive discs bonded together with two interlayers 309 which may or may not be the same. Embodiment 330 includes centrally disposed core 304 and peripheral annulus 302.

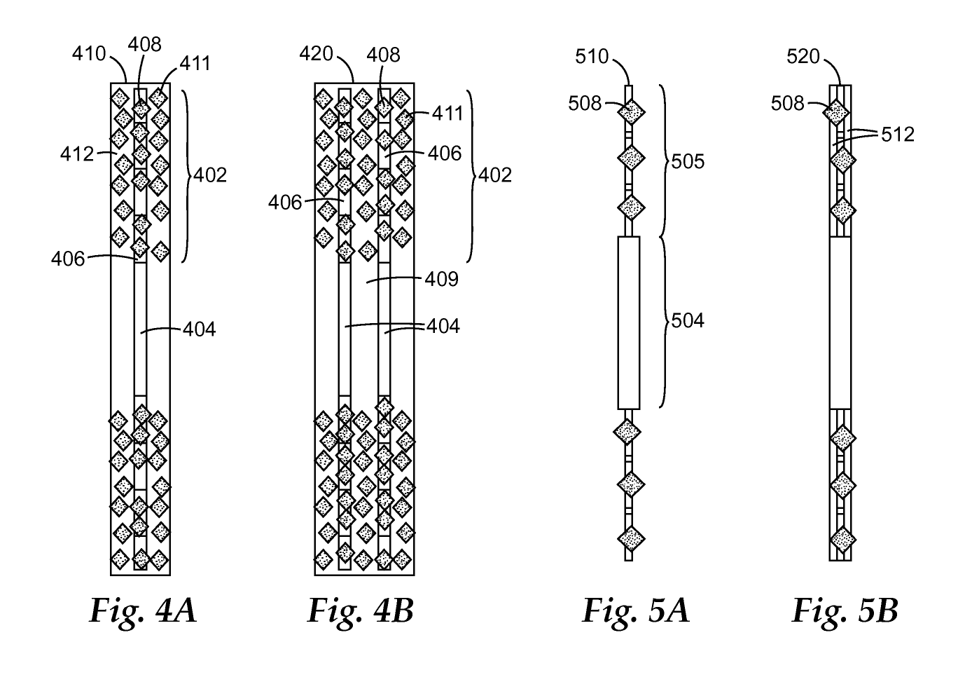

FIGS. 4A and 4B are edge-on illustrations of two additional embodiments, 410 and 420 of provided abrasive articles. Embodiment 410 includes an integral resilient disc that has centrally disposed portion 404 and peripheral annulus 402 that has cells 406 containing abrasive particles 408 defining abrasive zones. External retention material 412 that includes abrasive particles 411 is in contact with at least a portion of at least one of the plurality of adhesive zones defined by cells 406 that include abrasive particles 408. External retention material 412, in the embodiment illustrated in FIG. 4A, has abrasive particles, in contact with peripheral annulus 402 of the integral resilient disc. The external retention material typically is made of the same sinterable retention material used in the rest of the resilient disc. It can, however, be another material that can include the same components but in a different ratio, ceramics, polymers, or other materials designed to hold abrasive particles in cells and/or assist in decreasing friction between the abrasive disc and a machined work-piece. Abrasive particles 411 can or cannot be in contact with or protrude from or through the first and second opposed major surfaces of the peripheral annulus of the integral resilient disc or abrasive disk.

FIG. 4B shows embodiment 420 that has the same features as the embodiment illustrated in FIG. 4A but includes two integral resilient discs having centrally disposed cores 404, peripheral annuluses 402 that include abrasive particles 408 contained within cells 406 and that have retention material surrounding the peripheral annuluses that can contain abrasive particles 411. Part of the matrix material can lie between the two integral resilient discs and acts as an interlayer 409. Blades that include several (multi-layered) integral resilient discs are usually stiffer and mechanically more robust than blades that include a single integral resilient disc.

FIGS. 5A and 5B together illustrate another embodiment of a provided abrasive article. FIG. 5A is an embodiment similar to that illustrated in FIG. 2B or integral resilient disc 510 that has centrally disposed portion 504 and peripheral annulus 505 in the form of a fin that includes abrasive particles 508. FIG. 5B is an edge-on illustration of embodiment 520 that includes the embodiment illustrated in FIG. 5A which has been provided with two outward layers 512 on each side of fin 505 in FIG. 5A. The outward layers 512 reinforce the abrasive periphery of article (blade) 520 and can include hard abrasive particles in a random or patterned array. As in previous embodiments, the predominately solid core of the disc provides overall integrity of the blade. Also as in previous embodiments, the cellular annulus and cellular fin provide support and integrity to the most vulnerable parts of the blade—the retention material and the hard abrasive particles. Due to the small thickness of the integral resilient disc or fin, the material of the disc or fin can wear away and break easily in the process of blade cutting a work piece (wear faster than the retention material) thereby presenting no or minimal resistance (obstacle) to wear and performance of the blade.

Provided abrasive articles that include an abrasive annulus can be dressed and trimmed. An abrasive fin also can be formed by dressing abrasive annulus originally about as thick as the core. In this case, the integral resilient disc within the processed, for example, sintered abrasive disc support can also reinforce the abrasive disc and/or a part, for example, abrasive annulus, of the abrasive disc.

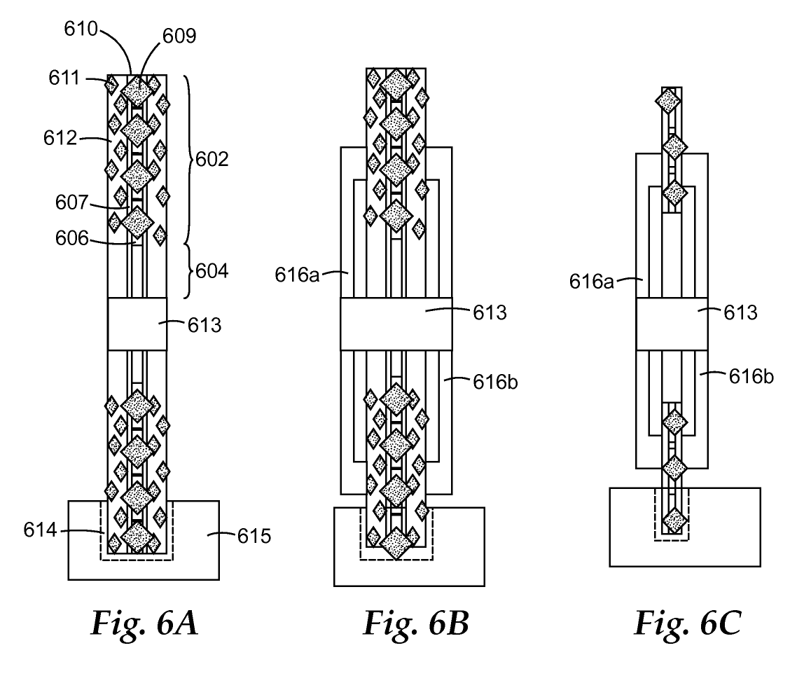

FIG. 6A illustrates an embodiment of provided abrasive article 610 that includes an integral resilient disc that has centrally disposed core 604 and peripheral annulus 602. Peripheral annulus 602 includes cells 606 that include abrasive particles 609, outward layers 607, and retention material or matrix 612 that includes other abrasive particles 611. Centrally disposed core 604 includes shaft opening 613 useful for mounting article 610 on a spindle of a tool. FIG. 6A further shows how integral resilient disc 610 can cut into substrate 615 producing kerf 614. FIG. 6B shows an embodiment that includes the integral resilient disc illustrated in FIG. 6A that also includes support flange 616 (readily available in the industry) to maintain the abrasive disk or blade. Support flange 616 can comprise two parts 616a and 616b interconnected with (fixed to) each other, for example, via a thread, and can include a shaft opening (such details are not shown in FIG. 6B). Being properly interconnected with each other, parts 616a and 616b of support flange 616 grip (clench, nip, pinch) and hold the blade between them via compressive and friction forces at least in a process of rotating blade on the saw and cutting work-piece by the blade. A work-piece is cut with (by) a part of the blade protruding over the very outside edge of the holder or support flange 616. Parts 616a and 616b can be taken apart to release or remove the blade gripped between them.

FIG. 6C is an illustration of an embodiment of an abrasive article that includes a single integral resilient disc and also includes support flange 616 to hold the blades as illustrated in FIG. 6A without showing retention materials. Support flanges 616 illustrated in FIGS. 6B and 6C can be made from any rigid material and are typically aluminum, zirconium, or an alloy, for example, stainless steel, composite, or polymeric. Support flanges can include at least two parts and/or be two sided (as conventionally shown as part 616 in FIGS. 6B and 6C) or can include one part and/or be single sided, and can be temporarily or permanently fixed to the abrasive disc or blade. FIG. 6C is an illustration of an embodiment of an integral resilient disc and abrasive disk/blade as illustrated in FIG. 6A without retention material that also includes support flanges 616 to hold the blades.

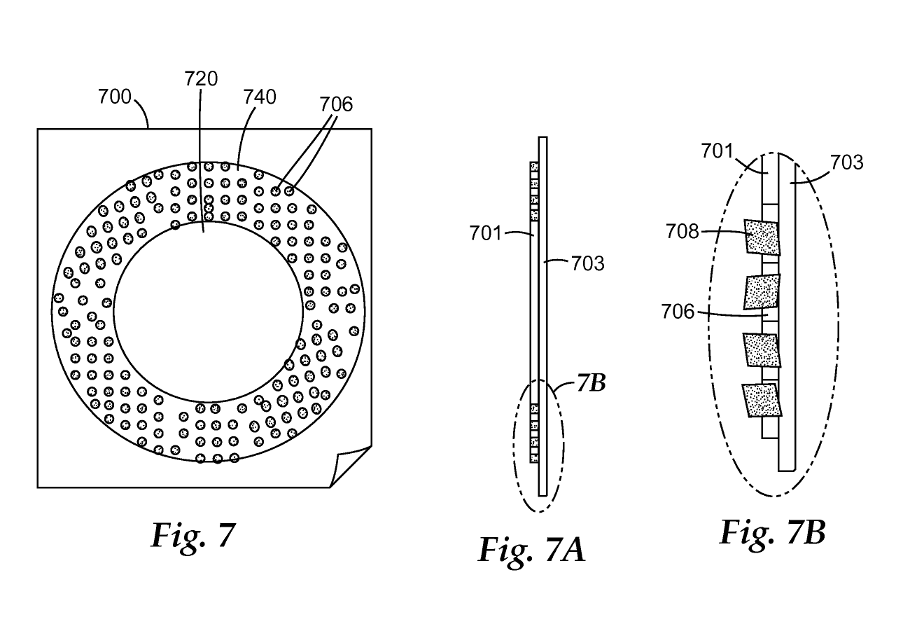

FIG. 7 is a top-down view of mask 700 similar to plate 100 shown in FIG. 1 and its complements that can be used to make an embodiment of a provided integral resilient disc. Mask 700 has core 720 centrally disposed relative to peripheral annulus 740 or relative to both peripheral annulus 740 and edges of mask 700. Peripheral annulus 740 includes holes or cells 706. FIG. 7A is an edge-on illustration of mask 701 that is laminated to adhesive sheet 703. FIG. 7B is an exploded view of a portion of FIG. 7A and shows abrasive particles 708 that have been disposed in cells 706 of mask 701 that are at least partially in contact and temporarily retained with adhesive or tacky material or layer 703 that can be an adhesive or tacky material by itself or a cover of the sheet. This article (an assembly of mask, adhesive material, diamonds with or without presence of retention material in its pre-processing stage) can be processed, for example sintered, if provided with sinterable powdered materials, or deposited with a retention material to provide an embodiment of a provided abrasive article.

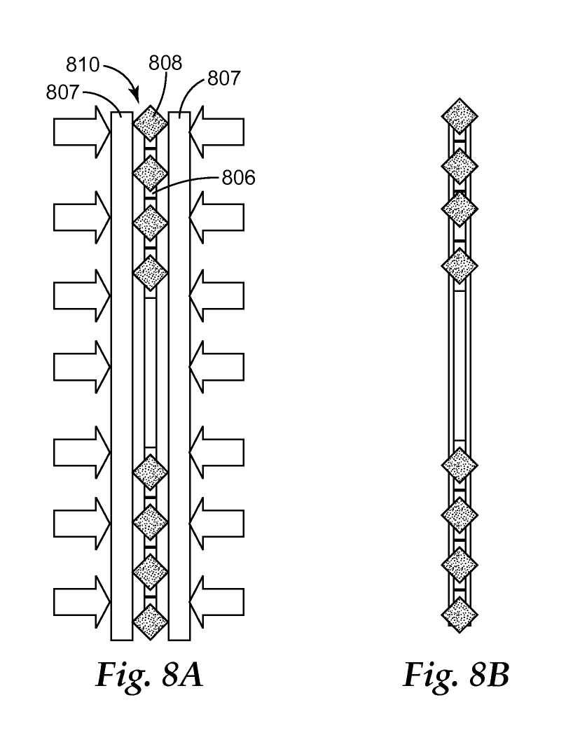

FIGS. 8A and 8B illustrate a process of making provided abrasive articles. In embodiment 810, abrasive particles 808 are disposed in cells 806 of a plate (mask), for example, such as 700 in FIG. 7, or a plate 100, for example, such as 100 in FIG. 1, or an integral resilient disc, for example, such as 200 in FIG. 2. Sinterable retention material 807, for example, in a form of a preform or powder tape, is disposed on at least one the outer side of the plate or mask or integral resilient disc. The disc can then be processed under elevated pressure and/or temperature.—Pressure is applied in the direction (perpendicular to the facets of the plate) shown by the arrows to fix the abrasive particles at least into and/or onto the plate and/or integral resilient via integration of the sintered material with abrasive particles and the plate and/or integral resilient disc. The final product is illustrated in FIG. 8B and is similar to the embodiment shown in FIGS. 3, 3A, 3B, 3C, 4A, 4B, 5A and 5B. For example, powder preform or powder tape or soft and easily deformable powder is described in U.S. Pat. No. 5,620,498 (Tselesin).

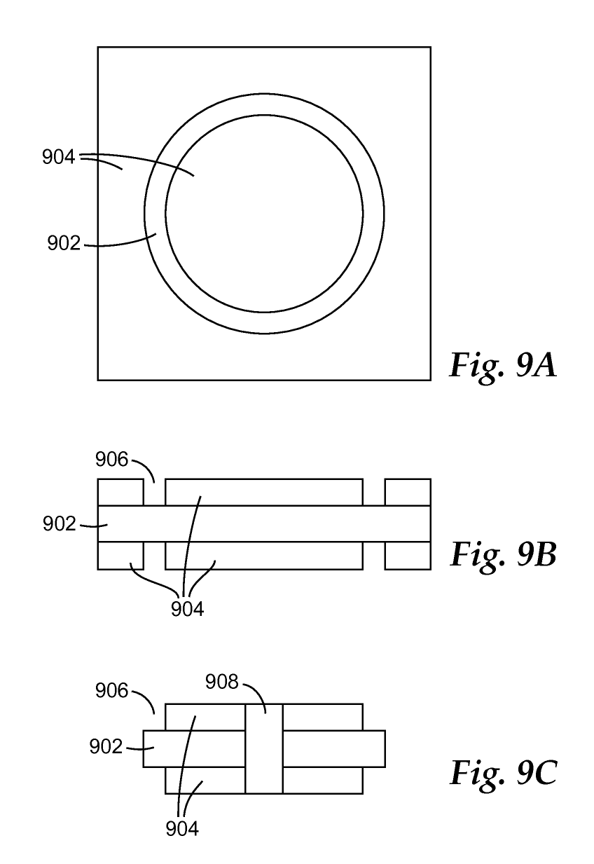

Yet another embodiment is illustrated by FIGS. 9A-9C. In this embodiment, a layer of sintered nickel/cobalt that includes abrasive particles is sandwiched between two outer layers of zirconium. Layers of support material are bonded to the sintered nickel/cobalt layer to make one integrated piece. FIG. 9A is a top-down illustration of a sheet that includes support layer 904 (bottom layer is below the plane of the paper) that has been etched away to expose annulus 902 (on both sides) that includes holes or cells that include diamonds. FIG. 9B is a side view of the same embodiment and shows layer 902 that includes cells that include diamonds 909 that is sandwiched between two support outer layers 904. Annulus 906 has been etched away though both support layers to expose what will become the peripheral annulus of a provided article. FIG. 9C shows the article after it has been extracted from the sheet. It includes core portion 902 that surrounds shaft opening 908. Peripheral annulus 902 is supported by supporting flange 904 made up of support layers (in one embodiment the support layers comprise zirconium) that supports the integral resilient disc on both sides. One embodiment illustrated in FIGS. 9A-9C can have a centrally disposed core that is substantially free of abrasive particles. Alternatively, another embodiment illustrated by FIGS. 9A-9C can have the layer that includes abrasive particles be continuous throughout the sheet. In this embodiment there is still a centrally disposed core that has been reinforced by the at least one support flange and a peripheral annulus provided by the etched-away area of the

The provided abrasive articles can be extracted from plates, webs, or other structures that have one or more preformed article disposed thereon. In one embodiment, the structure having regions containing abrasive particles can be processed at elevated temperature, for example, sintered with or without the presence of a liquid phase, typically under pressure and/or load.—In this or any other embodiment or combination of embodiments, the structure having abrasive zones containing abrasive particles and can include infiltrated material of the molten phase before and/or during and/or after or, in some embodiments, in the absence of sintering. Molten material or infiltrate can derive from retention material, disc material, or can be delivered from an external source (from outside of the assembly). In addition, the sinterable material can include fusible and/or brazable materials and/or additives that when molten can penetrate/infiltrate into non-molten material or solid fraction (skeleton), for example, of sinterable material. Thus “sinterable retention material” is intended to include, but is not limited to, fusible and brazable materials as discussed, for example, in U.S. Pat. No. 5,380,390 (Tselesin). It is to be noted that processing at elevated temperature, for example, sintering includes, but is not limited to, processing at atmospheric or room pressure, at negative (vacuum) pressure or at positive pressure, including also placing the material under pressure and/or load. Processing can occur in the presence of a protective and/or reduction, and/or oxidizing, and/or neutral atmosphere, in a solid and/or liquid phase and/or in the partial presence of the liquid phase; in a mold or tray, in a furnace or in a press, for example, sinter press.

One method for providing an abrasive article having a centrally disposed core containing essentially no abrasive particles and a peripheral annulus containing abrasive particles includes blocking designated regions when making the structure by the use of a mask as disclosed in U.S. Pat. Nos. 5,380,390; 5,817,204; and 5,980,678 (all Tselesin). Alternatively, the article can be prepared by depositing a first material with a lower concentration of or even no abrasive particles into one section of an assembly, depositing a second material having a higher concentration of particles in other section(s) and then processing, for example, sintering the materials to form a unitary structure. The resulting structure has regions containing abrasive particles and regions containing essentially no abrasive particles. Another method of providing an abrasive article includes providing a plurality of blocks of sinterable matrix material containing about the same or differing amounts of abrasive material, assembling the blocks in abutting relationship to form an assembly and then sintering the assembly, preferably under pressure and/or load, to form a unitary structure containing portions that contain particles and portions that do not. For example, abrasive articles derived from abutting blocks are described in U.S. Pat. No. 6,453,899 (Tselesin).

Provided abrasive articles can be extracted from a plate, web, or other structures by means of, for example, electrical erosion, laser, electron beam, gas-arc, water-jet cut with or without a utilization of the mechanical breakage or fracturing before, during, or after application of said means or any combination thereof. The extracting may be along the border or junction lines between the portions or at least partially through or predominately through a peripheral annulus of the article. Preferably, the extracting method is by cutting with a laser or water-jet that goes exclusively through the peripheral annulus of the structure. Alternatively, abrasive products can be “scooped” out of the structure. For example, extraction of abrasive articles from processed assembly described in U.S. Pat. Nos. 6,482,244 and 6,453,899 (all to Tselesin).

The articles extracted from the structure can be further processed into any desired shape or look. These include cutting, dressing, truing, compacting, heating, cooling, sintering, coning, forging, extruding, brazing, infiltrating, impregnating, cleaning, painting, coating, plating, adhering, etching, molding and machining which may include deburring, laser, electron beam, flame jet, water jet cutting, drilling, milling and grinding or any combination thereof.

Typically, the extracted sintered abrasive article or tool can be shaped to be fixed to a tool carrier, such as an arbor or carrier of a circular abrasive cutting blade, wheel, or shaft of cutting saw. Prior to mounting on the carrier, the extracted processed, sintered abrasive article, can be machined, re-cut, de-burred, trimmed, and dressed. The provided articles can be used as grinding wheels, rotary dressers, or the elements as the cutting and/or grinding segments of abrasive machining or cutting tools. Examples of individual extracted processed abrasive segments for a tool include cutting members for cutting and/or edge tools, such as segments for tips for circular, chain, reciprocating and wire cutting blades. Further examples of the use of such tools include cutting, grinding, polishing, lapping, dressing, milling, roughening, chamfering, de-burning, gripping, and friction tools. More specifically, the members can be used to form abrasive segmented cutting blades, abrasive segmented drill bits, continuous or imitation of the continuous abrasive surfaces or rims but with the segments fixed, adjusted and/or joined to each other, e.g., by welding, braising, and/or mechanical mounting to imitate a continuous motion and tools having combinations of such characteristics. Examples are face-grinding tools, cylindrical tools and other rotary tools, wheels, pencil wheels, and conical tools. Examples of materials that can be machined with these tools include sintered materials, composites, electronic packaging materials, ceramics, glass, wafer, semiconductor, alloy, steel, metallic, non-metallic, fiber, graphite, carbon materials, hard metals, asphalt, natural or artificial stones, precision stones, concrete, rocks, abrasives and super-abrasives, counters and floors made out of natural stone, artificial stone, or concrete.

A method of making an abrasive article is provided that includes providing an integral resilient member (plate, disc, foil, or mask) having a first and second opposed major surface, the resilient member including a centrally disposed core and a peripheral annulus, wherein the peripheral annulus comprises a plurality of cells, wherein the cells penetrate through or open to at least one major surface of the peripheral annulus, and wherein the core is substantially free of cells, disposing abrasive particles into the cells, and processing the member-so that the abrasive particles are fixed in the cells by permanent retention mean. Additionally the method can include providing temporarily retention material and a material from which the permanent retention material derives (for example, a powder that turns under elevated temperature into the permanent retention material). The integral resilient members have been described above.

Abrasive particles can be introduced into the plurality of cells in the peripheral annulus by any number of means known to those having ordinary skill in the art. They can be introduced, for example, by falling, shaking, sifting, brushing, pushing, blasting, shooting or automated placement. The abrasive particles can be temporarily held in place by placing an adhesive adjacent to at least some areas of one major surface of the peripheral annulus and allowing abrasive particles to fall or sift into holes on the opposing major surface of the resilient member. The abrasive particles, in the holes of the resilient member, are then temporarily held in place by the adhesive until an integration process such as, for example, sintering, allows them to be fixed in place. After abrasive particles are disposed into the cells of the peripheral annulus, the resilient member can be processed to fix the particles. Fixing can involve any process that causes diffusion and/or reaction between elements and/or forms a fluid or molten material that can then be solidified. Fixing can include sintering of the assembly comprising the resilient member, or the addition of another material that can be sintered, infiltrated/impregnated-saturated deposited, thermoset, or thermoformed. These additional materials can include, for example, powders comprising metal, thermoplastic resins, thermosetting resins, or powder comprising ceramics. The process can include thermal treatment to melt, fuse, cure, crosslink, quench, cool, anneal, shot blasting, striking, freezing, electrical and magnetic treatment or otherwise process the material. Examples of processes useful for the provided method include sintering at relatively low (900° C. or lower) or relatively high (greater than 900° C.) temperatures, heating to melt the materials, applying pressure, or exposing the materials to electromagnetic radiation (for example, UV, visible, IR, and e-beam).

Another method of making an abrasive article is provided that includes the steps of providing a providing an integral resilient member having first and second opposed major surfaces, the member comprising a centrally disposed core, and bonding a peripheral annulus having openings or cells onto the centrally disposed core laser or electron beam welding, brazing, sintering, heating, fusing, infiltrating, pressurizing, stamping, forging, or a combination thereof, wherein the peripheral annulus includes at least one abrasive zone that comprises abrasive particles that protrude from at least one major surface of the integral resilient member, wherein the abrasive zones extend outwardly from at least one major surface, and wherein the core is substantially free of abrasive zones.

The peripheral annulus or annuluses or fins of the resilient member can include material characterized with temperature of melting that is lower than temperature of melting of the core of the resilient member. At elevated temperature, for example during sintering, such annuluses can melt while the core is solid, and at least partially infiltrate into retention material therefore modifying composition of the retention materials and providing, at least partially, a presence of cells in the abrasive article. In this case abrasive particles disposed in the cells remain in their original positions after sintering.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

What is claimed is:

1. An abrasive article comprising:
an integral resilient member having a first and a second opposed major surface, the member comprising:
a centrally disposed core; and
a peripheral annulus comprising a plurality of openings or cells,
wherein the peripheral annulus comprises a plurality of abrasive zones that comprise abrasive particles that protrude through at least one of the major surfaces of the integral resilient member,
wherein the abrasive zones extend outwardly from the at least one major surface, and
wherein the core is substantially free of abrasive zones.

2. An abrasive article according to claim 1, wherein the integral resilient member comprises a disc.

3. An abrasive article according to claim 2, wherein at least some of the abrasive particles protrude through both the first major surface and the second major surface of the integral resilient member.

4. An abrasive article according to claim 1, wherein the centrally disposed core is substantially solid.

5. An abrasive article according to claim 1, wherein the centrally disposed core comprises a sinterable material that comprises at least one element selected from Groups 3-15 of the Periodic Table.

6. An abrasive article according to claim 5, wherein the elements are selected from copper, nickel, iron, molybdenum, cobalt, aluminum, and zirconium, steel, stainless steel, bronze, and combinations thereof.

7. An abrasive article according to claim 1, wherein the peripheral annulus comprises at least one element of groups 3-15 of the Periodic Table.

8. An abrasive article according to claim 1, wherein the thickness of the article is less than about 200 micrometers at its thickest point.

9. An abrasive article according to claim 1, wherein the thickness of the peripheral annulus of the article is less than the thickness of the core of the article.

10. An abrasive article according to claim 9, wherein the thickness of the peripheral annulus of the article is less than about 100 micrometers.

11. An abrasive article according to claim 10, wherein at least a portion of the peripheral annulus of the article further comprises a fin.

12. An abrasive article according to claim 11, wherein the fin has a thickness of less than about 60 micrometers.

13. An abrasive article according to claim 1, further comprising external retention material that includes abrasive particles,
wherein the external retention material is in contact with at least a portion of at least one of the plurality of abrasive zones, and
wherein the abrasive particles do not extend at least from the first major surface to the second major surface through the integral resilient disc.

14. An abrasive article according to claim 1, further comprising a support flange.

15. An abrasive disc comprising:
an abrasive layer having first and second opposed major surfaces comprising a plurality of openings or cells; and
at least one layer of support material disposed upon at least one side of the abrasive layer,
wherein the abrasive layer comprises a plurality of abrasive zones that comprise abrasive particles that protrude through at least one of the major surfaces of the abrasive layer,
wherein the abrasive layer extends beyond the at least one layer of support material and forms a peripheral annulus, and
wherein the at least one layer of support material forms a supporting flange for the abrasive disc.

16. An abrasive disc according to claim 15, comprising two layers of support material, one layer disposed upon the first major surface of the abrasive layer and one layer disposed upon the second major surface of the abrasive layer.

17. An abrasive article comprising:
two or more integral resilient members, each member having a first and a second opposed major surface, at least one of the members comprising:
a centrally disposed core; and
a peripheral annulus comprising a plurality of openings or cells; and
an interlayer disposed between and in contact with at least one major surface of each member,
wherein the peripheral annulus comprises a plurality of abrasive zones that comprise abrasive particles that protrude through the at least one major surface of the integral resilient member,
wherein the abrasive zones extend outwardly from the at least one major surface,
wherein the core is substantially free of abrasive zones, and
wherein the interlayer comprises an abradable material.

18. An article according to claim 17, wherein at least one of the resilient integral members comprises a disc.

19. An article according to claim 18, wherein at least some of the abrasive articles protrude through both the first major surface and the second major surface of the at least one integral resilient member.

20. An article according to claim 17, further comprising a support flange.

21. A method of making an abrasive article comprising:
providing an integral resilient member having a first and second opposed major surface, the member comprising:
a centrally disposed core; and
a peripheral annulus comprising a plurality of openings or cells,
wherein the cells penetrate through at least one major surface of the integral resilient member, and
wherein the core is substantially free of cells;
disposing abrasive particles into the cells; and
processing the integral resilient disc so that the abrasive particles are fixed in the cells.

22. A method according to claim 21, further comprising applying retention material to cells.

23. A method according to claim 22, wherein the retention material comprises an adhesive.

24. A method according to claim 21, wherein the processing includes heating, pressurizing, laser or electron beam welding, brazing, soldering, sintering, fusing, infiltrating, stamping, or a combination thereof to the member.

25. A method of making an abrasive article comprising:
providing a providing an integral resilient member having first and second opposed major surfaces, the member comprising a centrally disposed core; and
bonding a peripheral annulus having openings or cells onto the centrally disposed core using laser or electron beam welding, brazing, sintering, heating, fusing, infiltrating, pressurizing, stamping, forging, or a combination thereof,
wherein the peripheral annulus comprises at least one abrasive zone that comprises abrasive particles that protrude from at least one major surface of the integral resilient member, wherein the abrasive zones extend outwardly from at least one major surface, and
wherein the core is substantially free of abrasive zones.

26. A method of making an abrasive disc comprising:
providing a sheet that includes an abrasive layer having first and second opposed major surfaces comprising:
a plurality of openings or cells; and
at least one layer of support material disposed upon at least one side of the abrasive layer,
etching through the at least one layer of support material to expose the abrasive layer; and
extracting the abrasive disc from the sheet,
wherein the abrasive layer comprises a plurality of abrasive zones that comprise abrasive particles that protrude through at least one of the major surfaces of the abrasive layer, and
wherein the abrasive layer extends beyond the at least one layer of support material and forms a peripheral annulus, and
wherein the at least one layer of support material forms a supporting flange for the abrasive disc.
